(19) United States
(12) Patent Application Publication
(10) Pub. No.: US 2009/0228560 A1
(43) Pub. Date: Sep. 10, 2009

(54) METHOD AND APPARATUS FOR CLASSIFYING ELECTRONIC MAIL MESSAGES

(75) Inventor: Steven A. Sholtis, El Dorado Hills, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/044,511

(22) Filed: Mar. 7, 2008

(51) Int. Cl. G06F 15/16

(52) U.S. Cl. 709/206

(57) ABSTRACT

A system for classifying an electronic mail message is presented. During operation of the system, type tags are included in an electronic mail message, wherein the type tag can be used to classify the electronic mail message. Furthermore, specified actions can be performed based on the type tags included in the electronic mail message.

### BACKGROUND

### Related Art

The present invention relates to techniques for classifying electronic mail messages.

As users receive increasingly larger numbers of electronic mail messages, organizing these electronic mail messages is becoming an increasingly difficult task. One solution to this problem is to create rules in an electronic mail client to automatically categorize electronic mail messages as they are received. Unfortunately, these rules can be burdensome to create and to maintain.

### SUMMARY

Some embodiments of the present invention provide a system for classifying an electronic mail message. In this system, type tags can be included in an electronic mail message which can be used to classify the electronic mail message. Furthermore, specified actions can be performed based on the type tags included in the electronic mail message.

Some embodiments of the present invention provide a technique to generate an electronic mail message. In these embodiments, the type tags can be included with the contents of the electronic mail message. For example, the type tags can be included in a header field, the subject field, and/or the body of the electronic mail message.

Some embodiments of the present invention provide a technique for replying to an electronic mail message which includes type tags. In these embodiments, type tags can be included in the reply to the electronic mail message based on the type tags included in the electronic mail message.

### BRIEF DESCRIPTION OF THE FIGURES

FIG. 1A presents a block diagram illustrating a computer system in accordance with an embodiment of the present invention.

FIG. 1B presents a block diagram of an electronic mail module in accordance with an embodiment of the present invention.

FIG. 2 presents a flow chart illustrating a process for classifying an electronic mail message in accordance with an embodiment of the present invention.

FIG. 3 presents a flow chart illustrating a process for prompting a user to classify an electronic mail message in accordance with an embodiment of the present invention.

FIG. 4 presents a flow chart illustrating a process for associating specified actions with type tags in accordance with an embodiment of the present invention.

FIG. 5 presents a flow chart illustrating a process for generating an electronic mail message which includes type tags in accordance with an embodiment of the present invention.

FIG. 6 presents a flow chart illustrating a process for replying to an electronic mail message in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description can be embodied as code, data structures, and/or data, which can be stored on a computer-readable storage medium as described above. When a computer system reads and executes the code and/or data stored on the computer-readable storage medium, the computer system performs the methods and processes embodied as code, data structures, and/or data that are stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

Some embodiments of the present invention allow a user to associate type tags with an electronic mail message when the user creates the electronic mail message. In these embodiments, an electronic mail application allows a user to select a predefined type tag or to create a new type tag. If a new type tag is created, the new type tag can be added to a library of type tags. In some embodiments, the type tags are included in a header field of the electronic mail message. For example, the type tags can be included within an X-Header field for the electronic mail message.

In some embodiments, type tags that are included in received electronic mail messages are added to a library of type tags if they are not already included in the library of type tags. In some embodiments, the type tags are automatically added to the library of type tags. In other embodiments, the user is notified that new type tags are associated with an electronic mail message and is prompted to add the type tags to the library of type tags. Furthermore, the user can specify actions that are associated with a given type tag, which can also be stored within the library of type tags so that the next time the given type tag is received, the specified actions are performed. For example, if an “invoice” type tag is received, the specified actions can include moving the message to an “invoice” folder. In some embodiments, if a user does not add a new type tag to the library of type tags, electronic mail messages which include that type tag can be left in the inbox. In some embodiments, the type tag can be changed for a reply to or a forward of an electronic mail message which includes type tags.

### Computer System

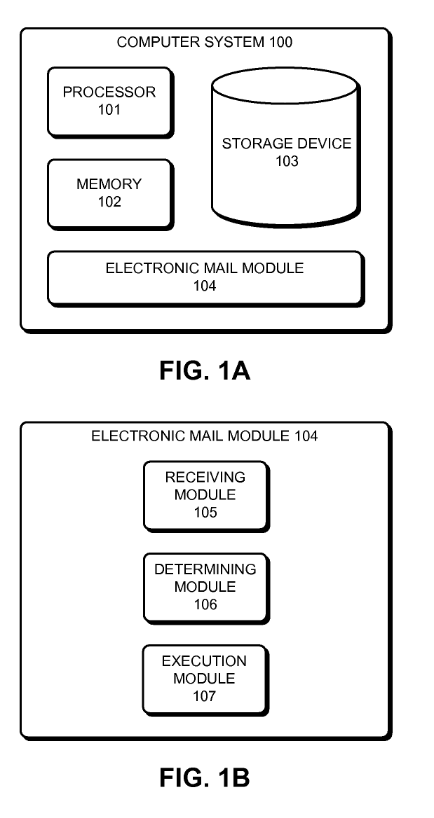

FIG. 1A presents a block diagram illustrating a computer system 100 in accordance with an embodiment of the present invention. Computer system 100 includes one or more of processor 101, memory 102, storage device 103, and electronic mail module 104.

Processor 101 can generally include any type of processor, including, but not limited to, a microprocessor, a mainframe computer, a digital signal processor, a personal organizer, a device controller and a computational engine within an appliance. Memory 102 can include any type of memory, including but not limited to, dynamic random access memory (DRAM), static random access memory (SRAM), flash memory, read only memory (ROM), and any other type of memory now known or later developed. Storage device 103 can include any type of non-volatile storage device that can be coupled to a computer system. This includes, but is not limited to, magnetic, optical, and magneto-optical storage devices, as well as storage devices based on flash memory and/or battery-backed up memory.

In some embodiments of the present invention, electronic mail module 104 is separate from computer system 100. Note that electronic mail module 104 is described in more detail below with reference to FIG. 1B.

FIG. 1B presents a block diagram of electronic mail module 104 in accordance with an embodiment of the present invention. Electronic mail module 104 includes receiving module 105, determining module 106, and execution module 107. Receiving module 105 is configured to receive the electronic mail message. Determining module 106 is configured to determine whether the electronic mail message includes one or more type tags which are used to classify electronic mail messages. If determining module 106 determines that the electronic mail message includes one or more type tags, execution module 107 is configured to perform one or more specified actions.

In some embodiments, one or more of receiving module 105, determining module 106, and execution module 107 are included in one or more integrated circuit (IC) chips. For example, these IC chips can include, but are not limited to, application-specific integrated circuit (ASIC) chips, field-programmable gate arrays (FPGAs), and other programmable-logic devices now known or later developed.

### Classifying an Electronic Mail Message

Note that the discussion below generally refers to “a system,” which can include, but is not limited to, a computer system, a server, a client computer system, a cluster of computer systems, a PDA, a mobile device, a component within a plurality of components, and a module within a software application.

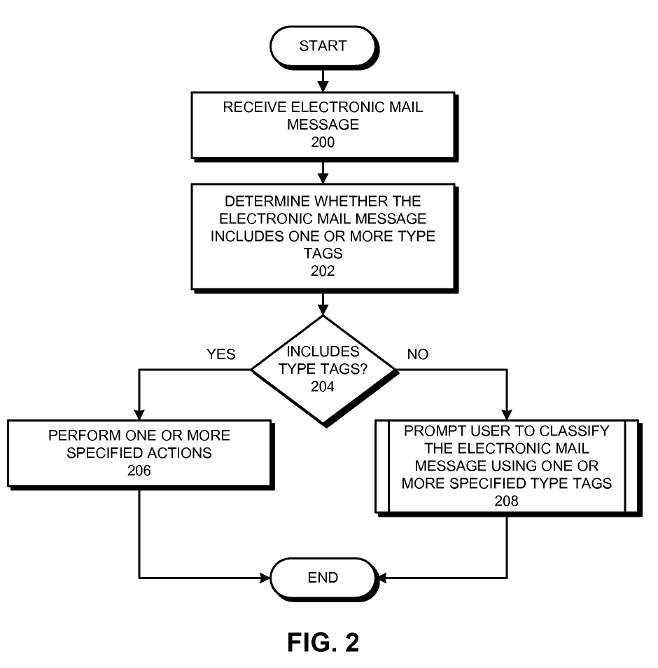

FIG. 2 presents a flow chart illustrating a process for classifying an electronic mail message in accordance with an embodiment of the present invention. The process begins when the system receives the electronic mail message (step 200). The system then determines whether the electronic mail message includes one or more type tags (step 202) which are used to classify electronic mail messages. In some embodiments, the one or more type tags are included in one or more of: an X-Header field of the electronic mail message; a header field of the electronic mail message; the body of the electronic mail message; and the subject of the electronic mail message.

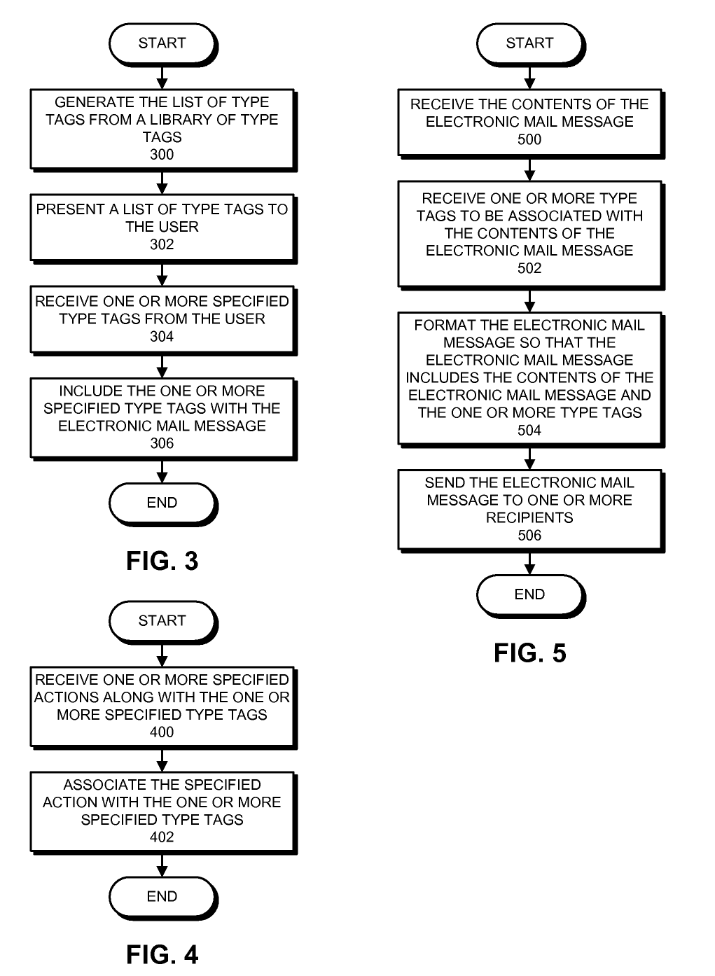

If one or more type tags are included in the electronic mail message (step 204, yes), the system performs one or more specified actions (step 206). Otherwise (step 204, no), the system prompts a user to classify the electronic mail message using one or more specified type tags (step 208). Note that step 208 is described in more detail with reference to FIG. 3 below.

In some embodiments, the one or more specified actions include one or more of: adding the one or more type tags to a library of type tags; tagging the electronic mail message based on the one or more type tags; categorizing the electronic mail message based on the one or more type tags; moving the electronic mail message to a folder associated with the one or more type tags; and automatically generating a response to the electronic mail message based on the one or more type tags. For example, if an incoming electronic mail message includes an “invoice” type tag, the system can classify the incoming electronic mail message as an invoice and/or move the incoming electronic mail message to an “invoice” folder. Similarly, if an incoming electronic mail message includes an “order” type tag, in response to the incoming electronic mail message, the system can automatically generate and send a response to the incoming electronic mail message which includes an “order confirmation” type tag.

FIG. 3 presents a flow chart illustrating a process for prompting a user to classify an electronic mail message in accordance with an embodiment of the present invention. The process begins when the system generates a list of type tags from a library of type tags (step 300). The system then presents the list of type tags to the user (step 302). Next, the system receives one or more specified type tags from the user (step 304). In some embodiments, if the one or more specified type tags are not already included in the library of type tags, after receiving the one or more specified type tags, the system stores the one or more specified type tags in the library of type tags. The system then includes the one or more specified type tags with the electronic mail message (step 306).

In some embodiments, specified actions can be associated with type tags. FIG. 4 presents a flow chart illustrating a process for associating specified actions with type tags in accordance with an embodiment of the present invention. The process begins when the system receives one or more specified actions along with the one or more specified type tags (step 400). Next, the system associates the specified action with the one or more specified type tags (step 402).

In some embodiments, the electronic mail message is received at one or more of: an electronic mail client; a webmail client; an Internet-enabled application; and a financial application.

### Generating an Electronic Mail Message

FIG. 5 presents a flow chart illustrating a process for generating an electronic mail message which includes type tags in accordance with an embodiment of the present invention. The process begins when the system receives the contents of the electronic mail message (step 500). In some embodiments, the contents of the electronic mail message include one or more of: a body of the electronic message; a subject of the electronic message; a recipient list; and one or more attachments.

The system then receives one or more type tags to be associated with the contents of the electronic mail message (step 502), wherein the one or more type tags are used to classify the electronic mail message. In some embodiments, prior to receiving the one or more type tags to be associated with the contents of the electronic mail message, the system determines the one or more type tags to be associated with the electronic mail message.

Next, the system then formats the electronic mail message so that the electronic mail message includes the contents of the electronic mail message and the one or more type tags (step 504). The system then sends the electronic mail message to one or more recipients (step 506).

### Replying to an Electronic Mail Message

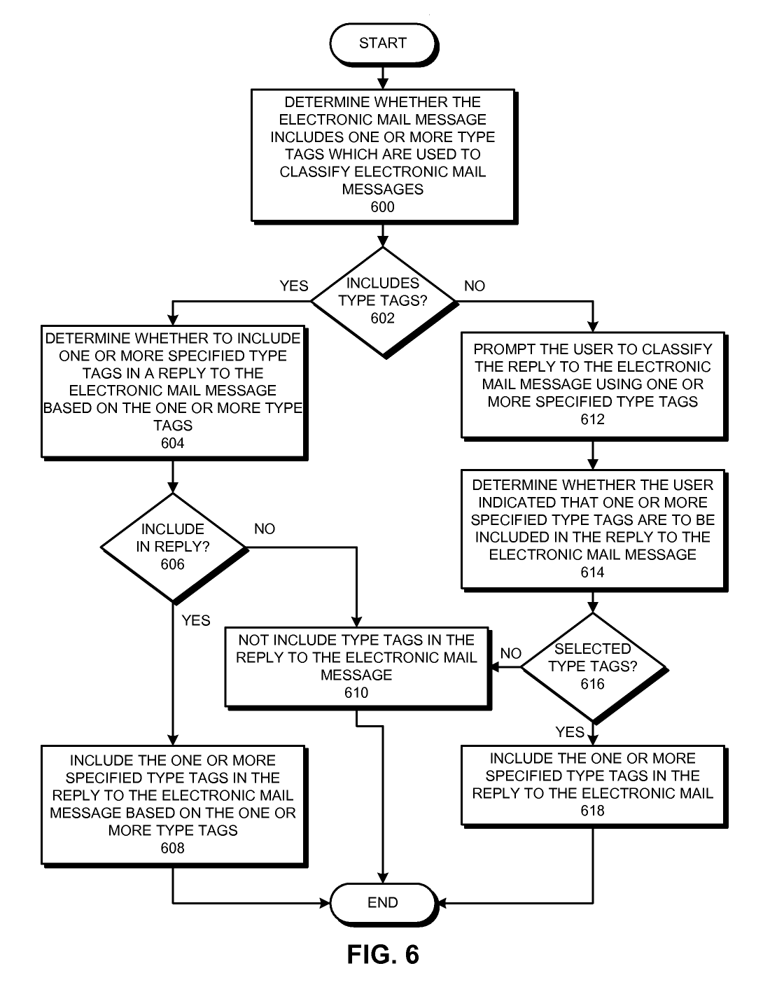

FIG. 6 presents a flow chart illustrating a process for replying to an electronic mail message in accordance with an embodiment of the present invention. The process begins when the system determines whether the electronic mail message includes one or more type tags which are used to classify electronic mail messages (step 600). If the electronic mail message include one or more type tags (step 602, yes), the system determines whether to include one or more specified type tags in a reply to the electronic mail message based on the one or more type tags (step 604). If the one or more specified type tags are to be included in the reply to the electronic mail message (step 606, yes), the system includes the one or more specified type tags in the reply to the electronic mail message based on the one or more type tags (step 608).

If the one or more specified type tags are not to be included in the reply to the electronic mail message (step 606, no), the system does not include type tags in the reply to the electronic mail message (step 610).

Returning to step 602, if the electronic mail message does not include one or more type tags (step 602, no), the system prompts the user to classify the reply to the electronic mail message using one or more specified type tags (step 612). The system then determines whether the user indicated that one or more specified type tags are to be included in the reply to the electronic mail message (step 614). If so (step 616, yes), the system includes the one or more specified type tags in the reply to the electronic mail message (step 618). Otherwise, the system does not include type tags in the reply to the electronic mail message (step 610).

Note that the process described in FIG. 6 can also be used when forwarding electronic mail messages.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for classifying an electronic mail message, comprising:
receiving the electronic mail message;
determining whether the electronic mail message includes one or more type tags which are used to classify electronic mail messages; and
if so, performing one or more specified actions.

2. The method of claim 1, wherein if the electronic mail message does not include a type tag, the method further comprises prompting a user to classify the electronic mail message using one or more specified type tags.

3. The method of claim 2, wherein prompting the user to classify the electronic mail message involves presenting a list of type tags to the user.

4. The method of claim 3, wherein prior to presenting the list of type tags to the user, the method further comprises generating the list of type tags from a library of type tags.

5. The method of claim 2, wherein after prompting the user to classify the electronic mail message, the method further comprises:
receiving one or more specified type tags from the user; and
including the one or more specified type tags with the electronic mail message.

6. The method of claim 5, wherein if the one or more specified type tags are not already included in the library of type tags, after receiving the one or more specified type tags, the method further comprises storing the one or more specified type tags in a library of type tags.

7. The method of claim 5, further comprising:
receiving one or more specified actions along with the one or more specified type tags; and
associating the specified action with the one or more specified type tags.

8. The method of claim 1, wherein the one or more specified actions include one or more of:
adding the one or more type tags to a library of type tags;
tagging the electronic mail message based on the one or more type tags;
categorizing the electronic mail message based on the one or more type tags;
moving the electronic mail message to a folder associated with the one or more type tags; and
automatically generating a response to the electronic mail message based on the one or more type tags.

9. The method of claim 1, wherein the one or more type tags are included in one or more of:
an X-Header field of the electronic mail message;
a header field of the electronic mail message;
the body of the electronic mail message; and
the subject of the electronic mail message.

10. The method of claim 1, wherein the electronic mail message is received at one or more of:
an electronic mail client;
a webmail client;
an Internet-enabled application; and
a financial application.

11. A computer-readable storage medium storing instructions that when executed by a computer cause the computer to perform a method for classifying an electronic mail message, wherein the method comprises:
receiving the electronic mail message;
determining whether the electronic mail message includes one or more type tags which are used to classify electronic mail messages; and
if so, performing one or more specified actions.

12. A method for generating an electronic mail message which includes one or more type tags, comprising:
receiving the contents of the electronic mail message;
receiving one or more type tags to be associated with the contents of the electronic mail message, wherein the one or more type tags are used to classify the electronic mail message; and
formatting the electronic mail message so that the electronic mail message includes the contents of the electronic mail message and the one or more type tags.

13. The method of claim 12, wherein the contents of the electronic mail message include one or more of:
a body of the electronic message;
a subject of the electronic message;
a recipient list; and
one or more attachments.

14. The method of claim 12, wherein prior to receiving the one or more type tags to be associated with the contents of the electronic mail message, the method further comprises determining the one or more type tags to be associated with the electronic mail message.

15. The method of claim 12, wherein the one or more type tags in the electronic mail message are included in one or more of:
an X-Header field of the electronic mail message;
a header field of the electronic mail message;
the body of the electronic mail message; and
the subject of the electronic mail message.

16. The method of claim 12, further comprising sending the electronic mail message to one or more recipients.

17. A computer-readable storage medium storing instructions that when executed by a computer cause the computer to perform a method for creating an electronic mail message which includes one or more type tags, wherein the method comprises:
receiving the contents of the electronic mail message;
receiving one or more type tags to be associated with the contents of the electronic mail message, wherein the one or more type tags are used to classify the electronic mail message; and
formatting the electronic mail message so that the electronic mail message includes the contents of the electronic mail message and the one or more type tags.

18. A method for replying to an electronic mail message, comprising:
determining whether the electronic mail message includes one or more type tags which are used to classify electronic mail messages;
if so, determining whether to include one or more specified type tags in a reply to the electronic mail message based on the one or more type tags; and
if the one or more specified type tags are to be included in the reply to the electronic mail message, including the one or more specified type tags in the reply to the electronic mail message based on the one or more type tags.

19. The method of claim 18, wherein the one or more specified type tags are included in one or more of:
an X-Header field of the reply to the electronic mail message;
a header field of the reply to the electronic mail message;
the body of the reply to the electronic mail message; and
the subject of the reply to the electronic mail message.

20. The method of claim 18, wherein if the one or more specified type tags are not to be included in the reply to the electronic mail message, the method further comprises not including type tags in the reply to the electronic mail message.

21. The method of claim 18, wherein if the electronic mail message does not include one or more type tags, the method further comprises:
prompting the user to classify the reply to the electronic mail message using one or more specified type tags;
determining whether the user indicated that one or more specified type tags are to be included in the reply to the electronic mail message;
if so, including the one or more specified type tags in the reply to the electronic mail message; and
otherwise, not including type tags in the reply to the electronic mail message.

22. A computer-readable storage medium storing instructions that when executed by a computer cause the computer to perform a method for replying to an electronic mail message, wherein the method comprises:
determining whether the electronic mail message includes one or more type tags which are used to classify electronic mail messages;
if so, determining whether to include one or more specified type tags in a reply to the electronic mail message based on the one or more type tags;
if the one or more specified type tags are to be included in the reply to the electronic mail message, including the one or more specified type tags in the reply to the electronic mail message based on the one or more type tags.

23. An apparatus that classifies an electronic mail message, comprising:
a receiving mechanism configured to receive the electronic mail message;
a determining mechanism configured to determine whether the electronic mail message includes one or more type tags which are used to classify electronic mail messages; and
an execution mechanism, wherein if the determining mechanism determines that the electronic mail message includes one or more type tags, the execution mechanism is configured to perform one or more specified actions.
